(19) United States
(12) Patent Application Publication
(10) Pub. No.: US 2009/0116822 A1
(43) Pub. Date: May 7, 2009

(54) IMAGE DISPLAYING SYSTEM

(75) Inventors: Ryosuke SHIMIZU, Osaka (JP); Fumio SAKAI, Mie (JP)

Correspondence Address: HAMRE, SCHUMANN, MUELLER & LARSON P.C., P.O. BOX 2902-0902, MINNEAPOLIS, MN, 55402, US

(73) Assignee: PANASONIC CORPORATION, Osaka (JP)

(21) Appl. No.: 12/256,090

(22) Filed: Oct. 22, 2008

(30) Foreign Application Priority Data
Oct. 26, 2007 (JP) 2007-279248

(51) Int. Cl. H04N 5/00

(52) U.S. Cl. 386/125; 386/E05.068

(57) ABSTRACT

A system includes a DVD recorder capable of recording and playing back video data using an HDD, a TV receiver capable of displaying TV broadcasts or effecting display based on the video data played back by the DVD recorder, and an HDMI interface that integrates the function of the two devices, i.e. the TV receiver and DVD recorder. The DVD recorder is powered on in step with the power-on of the TV receiver via the HDMI interface, enabling video data to be supplied from the DVD recorder to the TV receiver. When powered on, the DVD recorder maintains the magnetic disk of the HDD in rotation while the magnetic head is held above the surface of the magnetic disk. The magnetic head is retracted off of the surface of the magnetic disk upon elapse of a predetermined standby time in the absence of instructions regarding recording or playback. HDD malfunctions due to penetration of dust etc. in the gap between the magnetic head and magnetic disk when the magnetic head is held above the surface of the rotating magnetic disk for an extended period of time can be reduced using a simple configuration.

### BACKGROUND OF THE INVENTION

1. Field of the Invention

The present invention relates to an image displaying system adapted to connect an image display apparatus receiving and displaying TV broadcasts and an image recording/playback apparatus having a hard disk drive through a communication interface so as to integrate their function.

2. Description of Related Art

Generally speaking, image display apparatuses such as TV receivers not only receive and display TV broadcasts, but also are connected to image recording/playback apparatuses such as DVD recorders and display video images played back by the image recording/playback apparatuses. Moreover, typical image recording/playback apparatuses developed in recent years have a hard disk drive (abbreviated as “HDD” below) built in and possess function for recording TV broadcasts on the HDD.

HDMI (High-Definition Multimedia Interface) is an example of an interface used to connect a TV receiver to an image recording/playback apparatus. HDMI, which is a communication interface standard for the input and output of digital video images and audio intended for consumer electronics and AV devices, permits transmission and reception of a combination of video images, audio, and control signals over a single cable. By enabling transmission of control signals etc. in both directions, it provides for intelligent function that allows two connected devices to recognize each other, thereby making it easier to integrate a TV receiver and an image recording/playback apparatus.

Image recording/playback apparatuses typically are used when a user watches a TV broadcast and desires immediately to start recording the TV broadcast that is being watched. To address circumstances in which one wants to start recording immediately when a TV receiver and an image recording/playback apparatus are interconnected via an HDMI interface, the image recording/playback apparatus is powered on in step with the power-on of the TV receiver and the magnetic disk of the HDD is controlled to maintain constant rotation.

It should be noted that the magnetic head of the HDD is a “flying head”, which floats above the rotating magnetic disk at a height of about 10 nm in order to perform the operations of recording and playback. Such a state of the flying head relative to the magnetic disk will be explained with reference to FIG. 7.

The magnetic disk 40 illustrated in FIG. 7 is formed from rigid material and has a magnetic layer provided on its surface. A slider 41 is held in a position in which it floats at a predetermined spacing above the rotating magnetic disk 40. A magnetic head 41a, which is provided at the distal end portion of the slider 41, effects recording and playback on/from the magnetic disk 40. The slider 41 is held at the distal end of a load arm 42, which has its fixed end pivotally supported, and can be moved to any position on the magnetic disk 40 by an actuator (not shown). The effect that causes the slider 41 to float is produced when an air stream flows between the slider 41 and magnetic disk 40 during the rotation of the magnetic disk 40 and generates a lifting force. This keeps the size of the gap between the head and the disk constant.

The smaller the gap between the head and the disk, the more effective this is in achieving a higher HDD capacity. Accordingly, as mentioned above, the gap between the head and the disk is controlled to be extremely small, on the order of 10 nm. As a consequence, a considerable percentage of hard disk drive malfunctions is generated by problems arising between the head and the disk. For instance, when an HDD is incorporated into a notebook PC (personal computer), the body of the PC is quite likely to be subjected to shock while the magnetic disk is rotating, and, as a consequence, there is a high potential for situations in which the magnetic head may come into contact with the magnetic disk and the surface of the magnetic disk may sustain damage.

In order to avoid such situations as much as possible, it is preferable to retract the magnetic head off of the surface of the magnetic disk when not writing onto the magnetic disk or reading from the magnetic disk. Accordingly, there is provided a retracting mechanism, not shown in FIG. 7, that moves the load arm 42 in the plane of the magnetic disk 40 so as to bring the magnetic head 41a into a retracted position, in which it is not facing the surface of the magnetic disk 40. Using this retracting mechanism, the magnetic head 41a is brought into an unloaded state, in which it is retracted, or a loaded state, in which it floats over the surface of the rotating magnetic disk 40.

For instance, in an HDD disclosed in JP 2005-122796A, in order to suppress the occurrence of problems arising between the head and the disk, control is effected so as to retract the magnetic head in a safe retraction zone if abnormalities occur in the rotational speed of the magnetic disk during the loaded state of the magnetic head. When the rotational speed of the magnetic disk decreases, the lifting force that causes the magnetic head to float decreases and the magnetic head may end up contacting and sticking to the surface of the magnetic disk. When the head contacts or sticks thereto, the surface of the magnetic disk is damaged, resulting in a catastrophic failure affecting data stored on the HDD.

The rotational speed of the magnetic disk is controlled based on a clock signal supplied to the HDD. Accordingly, if there are frequency abnormalities in the clock signal, the rotational speed of the magnetic disk is not controlled with accuracy and the floating effect of the magnetic head no longer can be obtained properly. Accordingly, in the apparatus described in JP 2005-122796A, control is exercised to detect if abnormalities are present in the frequency of the clock signal inputted to the HDD and retract the magnetic head in the retraction zone when frequency abnormalities in the clock signal are detected.

However, it was found that, in HDDs used for image recording/playback apparatuses, malfunctions resulting from problems arising between the head and the disk occur under circumstances different from those of HDDs incorporated into notebook PCs.

In order to address the desire to start recording immediately in an image displaying system having a TV receiver and an image recording/playback apparatus with an HDD interconnected, e.g. via an HDMI interface, the image recording/playback apparatus, as explained above, is powered on in step with the power-on of the TV receiver and the magnetic disk of the HDD is controlled to maintain constant rotation.

The purpose of keeping the magnetic disk constantly rotating is to reduce the time required for the magnetic disk to reach the prescribed rotational speed. The HDD has multiple magnetic disks and, depending on the number of the disks (capacity), needs from a few seconds to about 20 seconds for power-on. Accordingly, if the rotation of the magnetic disks is initiated in response to operational input relating to recording, a delay of tens of seconds separates the start of recording from the recording instructions, and recording cannot be started right away. Due to the above circumstances, the magnetic disks of the image displaying system have to be maintained in a rotating state for an extended period of time. As described below, this is one of the factors leading to HDD malfunctions that presents no problem in notebook PCs.

In the past, unlike notebook PCs, image displaying systems did not perform the operation of magnetic head retraction even when the image recording/playback apparatus was not in use. This was due to the fact that, in image recording/playback apparatuses used in image displaying systems, the potential for sustaining a shock in a manner similar to a notebook PC was small and there was little need to avoid the resulting damage. On the other hand, in order to address the desire to start recording immediately, not only is it preferable to keep the magnetic disk rotating, but it is also desirable to maintain the magnetic head in a loaded state.

However, if the magnetic disk is kept rotating for an extended period of time with the magnetic head in a loaded state, the occurrence of HDD malfunctions increases with time as shown in FIG. 8. In FIG. 8, the HDD operating time is plotted along the abscissa while the HDD malfunction rate is plotted along the ordinate. The expression “HDD operating time” refers to the duration of the state in which the magnetic disk rotates while the magnetic head is in a loaded state. Such an increase in the malfunction rate is thought to be due to penetration of dust into the gap between the magnetic head and magnetic disk.

In order to avoid such HDD malfunctions, it has been proposed to provide semiconductor memory in the image recording/playback apparatus for storing video data over a predetermined period of time. Namely, as soon as a recording request is issued, the video data to be recorded is first temporarily stored in the semiconductor memory. Upon completion of HDD power-on, the video data accumulated in the semiconductor memory is transferred to the HDD, initiating the recording of video data on the HDD. However, this approach is expensive because it requires a large semiconductor memory.

In addition, in case of such HDD malfunctions, it is difficult to identify situations that bring about the malfunctions and predict the time when they may occur. Accordingly, it is difficult to address the issue by detecting the occurrence of situations conducive to malfunctions in accordance with the method disclosed in JP 2005-122796A.

In addition, since the magnetic head is adjacent to the magnetic disk in a loaded state, the rotation of the magnetic disk is subject to aerodynamic resistance. This results in unnecessary power consumption. For instance, under the typical device configuration and conditions, there is a difference in power consumption of about 1W between the loaded state and unloaded state of the magnetic head.

### SUMMARY OF THE INVENTION

In view of the above, it is an object of the present invention to provide an image displaying system which, based on a simple configuration, is capable of reducing to a practically sufficient degree the HDD malfunctions that arise due to penetration of dust etc. between a magnetic head and a disk when the magnetic head is held above the surface of the rotating magnetic disk for an extended period of time in situations specific to configurations, in which a TV receiver and an image recording/playback apparatus are connected so as to permit integration thereof.

Moreover, it is a further object to reduce power consumption in a loaded state of the magnetic head.

The image displaying system of the present invention comprises: an image recording/playback apparatus capable of recording and playing back video data using a hard disk drive; an image display apparatus capable of receiving and displaying TV broadcasts or effecting display based on the video data played back by the image recording/playback apparatus; and a communication interface for effecting communication between the image display apparatus and image recording/playback apparatus so as to integrate the function of both apparatuses. The image recording/playback apparatus is powered on through the communication interface in step with the power-on of the image display apparatus so as to allow for the video data played back by the image recording/playback apparatus to be supplied to the image display apparatus.

In order to solve the above-mentioned problem, the image recording/playback apparatus comprises a control section exercising control in such a manner that, upon power-on, along with maintaining the rotation of the magnetic disk in the hard disk drive, the magnetic head is placed in a loaded state, in which it is held above the surface of the magnetic disk, and, upon elapse of a predetermined standby time t in a loaded state without receiving operating instructions relating to recording or playback, the magnetic head is retracted off of the surface of the magnetic disk.

Using a simple configuration, the image displaying system of the above-described configuration can reduce, to a practically sufficient degree, HDD malfunctions that arise due to penetration of dust etc. between a magnetic head and a magnetic disk when the magnetic head is held above the surface of the rotating magnetic disk for an extended period of time because the magnetic head is retracted in the absence of instructions regarding recording or playback for a predetermined period of time. Moreover, it permits a reduction in power consumption in a loaded state of the magnetic head.

### BRIEF DESCRIPTION OF THE DRAWINGS

FIG. 1 is a block diagram of an image displaying system used in Embodiment 1 of the present invention.

FIG. 2 is a perspective view illustrating the general appearance of a hard disk drive used in an image recording/playback apparatus included in the same image displaying system.

FIG. 3 is a flow chart illustrating a magnetic head retracting operation in the same image recording/playback apparatus.

FIG. 4 is a flow chart illustrating a magnetic head retracting operation in Embodiment 2 of the present invention.

FIG. 5 is a flow chart illustrating a magnetic head retracting operation in Embodiment 3 of the present invention.

FIG. 6 is a flow chart illustrating a magnetic head retracting operation in Embodiment 4 of the present invention.

FIG. 7 is a side view illustrating the position of the magnetic head with respect to the magnetic disk in a conventional hard disk drive.

FIG. 8 is a diagram illustrating the relationship between the operating time and the magnetic disk malfunction rate in a conventional hard disk drive.

### DETAILED DESCRIPTION OF THE INVENTION

Based on the above-described configuration, the image displaying system of the present invention can take the following forms.

Namely, it is preferable that the control section exercises control with the standby time t set to t1 if the power-on of the image recording/playback apparatus is performed in step with the power-on of the image display apparatus, and exercises control with the standby time t set to t2 if the power-on of the image recording/playback apparatus is performed directly, with the standby times t1 and t2 set so as to satisfy the condition t1<t2.

Moreover, it is preferable that if the above-mentioned operating instructions are issued while control is exercised with the standby time t set to t1, the setting of the subsequent standby time t is changed from t1 to t2.

Furthermore, it is preferable that the control section has a function whereby the time P that elapses between the power-on of the image recording/playback apparatus or the issuance of an operating instruction and the issuance of the next operating instruction successively is measured and recorded, with the value of the standby time t2 changed based on statistical data regarding historical values of the elapsed time P measured a predetermined number of times.

In addition, it is preferable that the relationship between the standby times t1 and t2 is set so as to satisfy the condition 6×t1<t2.

Furthermore, it is preferable that the standby time t1 is set to 5 minutes or more. This is sufficient to address the desire to start recording immediately and makes it possible to minimize the probability of HDD malfunction occurrence.

Embodiments of the present invention are described below with reference to drawings.

### Embodiment 1

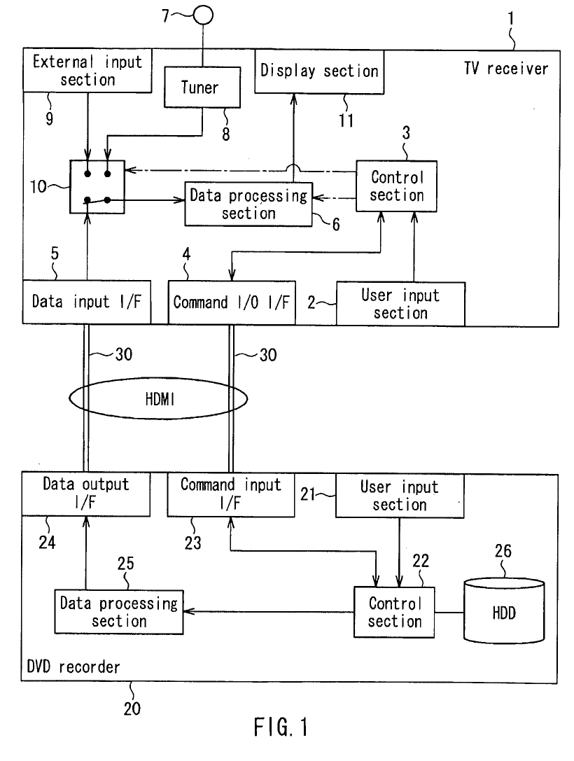

FIG. 1 is a diagram illustrating the configuration of an image displaying system made up of an image display apparatus and an image recording/playback apparatus, as used in Embodiment 1 of the present invention. A TV receiver (image display apparatus) 1 receives TV broadcasts and displays video images, etc. Additionally, it is capable of displaying images based on external video/audio signal input. A DVD recorder (image recording/playback apparatus) 20, which can be connected to the TV receiver 1, has an HDD 26, which is used for recording or playing back (referred to as “recording/playback” in the description below) video data in addition to an arrangement (not shown) used for recording and playback using DVDs.

The TV receiver 1 has a special remote control or a user input section 2 that receives op-code corresponding to operational input effected using input keys (not shown) provided on the main body of the TV receiver 1. In addition, the TV receiver 1 further includes a control section 3 that controls its operation, a command I/O I/F (interface) 4 that transmits command data, a data input I/F 5 that receives video images/audio/menu data etc., a data processing section 6 that processes inputted video images/audio/menu data etc., a tuner 8 into which broadcast signals received from an antenna 7 are inputted, an external input section 9 into which external video images/audio/menu data etc. are inputted, a switch 10 that selects a single input from among multiple inputs (external input section 9, tuner 8, and data input IF 5), a display section 11 that is constituted by a liquid crystal display panel, a plasma display panel, etc. displaying images based on video data etc.

The DVD recorder 20 also has a special remote control or a user input section 21 that receives op-code corresponding to operational input effected using input keys (not shown) provided on the main body of the DVD recorder 20. The DVD recorder 20 contains a control section 22 that controls its operation, a command I/O I/F 23 that transmits command data, a data output I/F 24 that transmits video images/audio/menu data etc., a data processing section 25 that processes video images/audio/menu data etc. to be outputted, and an HDD 26 used for recording and playing back inputted video images/audio etc. It should be noted that the diagram does not show components such as a tuner used for receiving broadcast signals and supplying them to the HDD 26, etc. Moreover, the DVD-based recording/playback section is not shown in the figure either.

The TV receiver 1 and DVD recorder 20 are connected through a communication cable 30, with video data, audio data, menu screen data, and command data exchanged therethrough. The TV receiver 1 and DVD recorder 20 are connected e.g. via an HDMI interface. The HDMI interface has three data channels and one clock channel (“TMDS channel”), as well as a display data channel (“DDC”) for exchanging configuration and status information between devices. Furthermore, the HDMI interface has an optional CEC line, which can be used for bidirectional transmission of control signals between various AV devices. For instance, transmission and reception of video data/audio data/menu screen data is carried out using the TMDS channel and that of command data is carried out via the CEC line. The command data also may be transmitted and received via the DDC. Instead of the HDMI interface, a similar function can be implemented using IEE1394.

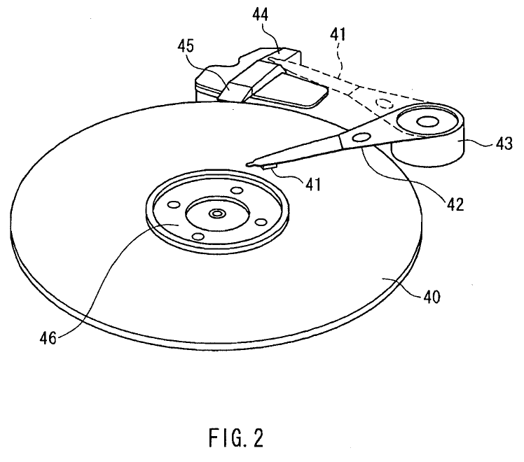

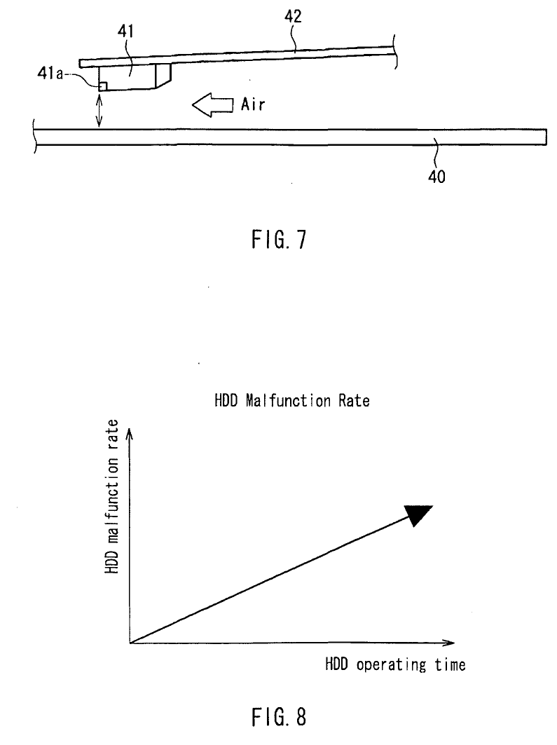

The HDD 26, which is incorporated into the DVD recorder 20, is configured as shown, for instance, in FIG. 2. Although only one magnetic disk 40 is shown in the same figure in order to illustrate the general configuration of the HDD, such a drive normally is provided with multiple magnetic disks 40. In FIG. 2, elements identical to the elements of the HDD illustrated in FIG. 7 are assigned the same reference numerals, and their explanation is not repeated.

The proximal end portion of the load arm 42, which has a slider 41 attached to its distal end, is rotatably supported by an actuator 43. The load arm 42 can be in a loaded state, in which the magnetic head provided on the slider 41 floats over the surface of the magnetic disk 40, and in an unloaded state, in which it is retracted in a head retraction portion 44 so as not to face the surface of the magnetic disk 40. When it switches from a loaded state to an unloaded state, the load arm 42 slides across the top face of a ramp section 45 and is guided smoothly to the head retraction portion 44. The reference numeral 46 designates a spindle motor driving the magnetic disk 40 in rotation.

In the image displaying system of the above configuration, the DVD recorder 20 uses the HDD 26 to record a broadcast signal, which then can be played back and supplied to the TV receiver 1. The TV receiver 1 displays images on the display section 11 based on the broadcast signal selected by the tuner 8. In addition, it can receive video data played back by the DVD recorder 20 through the communication cable 30 and effect image display based thereon.

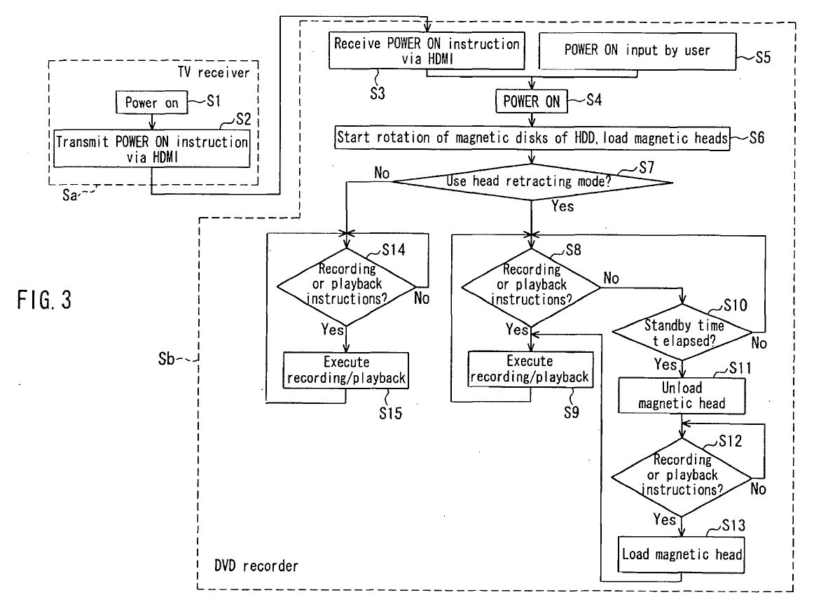

The operation of magnetic head retracting in the DVD recorder 20 of the thus configured image displaying system will be explained with reference to FIG. 1-FIG. 3. FIG. 3 is a flow chart illustrating the operation of magnetic head retracting in the present embodiment. In the same figure, the flow of processing in the TV receiver 1 is enclosed in dashed frame Sa while the flow of processing in the DVD recorder 20 is enclosed in dashed frame Sb.

First of all, when the TV receiver 1 is powered on (turned ON) (Step S1), the TV receiver 1 transmits a POWER ON instruction using the HDMI interface because the TV receiver 1 and DVD recorder 20 are connected using the HDMI interface (Step S2). The DVD recorder 20 receives the POWER ON instruction through the HDMI interface (Step S3). As a result, control is exercised in such a manner that the DVD recorder 20 is powered on in step with the power-on of the TV receiver 1 (Step S4).

On the other hand, the DVD recorder 20 sometimes is powered on (Step S4) without using the HDMI interface, based on direct operational input by the user on the DVD recorder 20 (Step S5).

When the DVD recorder 20 is powered on, the HDD 26 is powered on as well, and the magnetic disks start rotating (Step S6).

Within several tens of seconds after the power-on, the speed of rotation of all the magnetic disks 40 reaches a predetermined rotational speed and the operation of loading of the magnetic head (held by the distal end portion of the slider 41) onto the magnetic disk 40 is complete as well (Step S6). In a loaded state, the magnetic head floats, with the gap between it and the surface of the magnetic disk 40 maintained at a predetermined size. If an instruction is issued to the DVD recorder 20 to start recording or playback in this state, the HDD 26 can move the magnetic head into a predetermined position in the plane of the magnetic disk 40 in order to immediately start the operation of recording/playback.

Next, in Step S7, a selection is made as to whether to use the head retracting mode. The selection of the head retracting mode refers to a mode used to handle unloading, during which, as the occasion demands, the magnetic head is retracted in the head retraction portion 44 such that it does not face the surface of the magnetic disk 40, unlike the mode, in which the magnetic head is held in a loaded state. The selection may be configured to be preset in advance by the user or may be configured to be made on a case-by-case basis.

When a selection is made to use the head retracting mode, in Step S8, a determination is made as to the presence of operating instructions for the DVD recorder 20 regarding recording or playback. If the DVD recorder 20 has an instruction regarding recording or playback, the process moves to Step S9, in which the operations of recording or playback are carried out. Upon termination of recording/playback, the process goes back to Step S8 and the operation of determination as to the presence of recording/playback instructions is repeated.

As long as there are no recording or playback instructions in Step S8, in Step S10, the process waits until a predetermined standby time t elapses. Namely, it goes back to Step S8 and makes a determination as to the presence of recording or playback instructions until the standby time t elapses.

If the standby time t, e.g. a period of several minutes, passes without any recording or playback instructions being issued, the magnetic head is retracted off of the surface of the magnetic disk 40 and positioned in the retraction portion 44 in an unloaded state (Step S11). Next, in Step S12, a determination is made as to the presence of recording/playback instructions for the DVD recorder 20.

If the DVD recorder 20 has instructions regarding recording/playback, the process moves to Step S13, in which the operation of loading of the magnetic head onto the magnetic disk 40 is carried out. Next, the process moves to Step S9 to perform recording or playback, and, when the recording or playback is over, the process goes back to Step S8 and the above-described operations are repeated.

If there are no recording or playback instructions in Step S12, the unloaded state is maintained and the determination as to the presence of recording or playback instructions for the DVD recorder 20 is repeated.

On the other hand, when a selection is made not to use the head retracting mode in Step S7, in Step S14, a determination is made as to the presence of operating instructions for the DVD recorder 20 regarding recording or playback. If the DVD recorder 20 has instructions regarding recording or playback, the process advances to Step S15, in which the operations of recording or playback are carried out. Upon termination of recording or playback, the process goes back to Step S14 and the operation of determination as to the presence of recording or playback instructions is repeated.

As described above, once the magnetic head is brought in a loaded state after powering up the DVD recorder 20, the magnetic head is retracted in the absence of recording or playback instructions for a predetermined standby time t. As a result, the HDD malfunctions generated by the penetration of dust etc. in the gap between the magnetic head and magnetic disk when the magnetic head is held above the surface of the rotating magnetic disk for an extended period of time can be avoided to a practically sufficient degree with the help of a simple configuration. Moreover, a quick response is made possible because the loaded state is maintained if there are recording or playback instructions prior to elapse of the standby time t.

### Embodiment 2

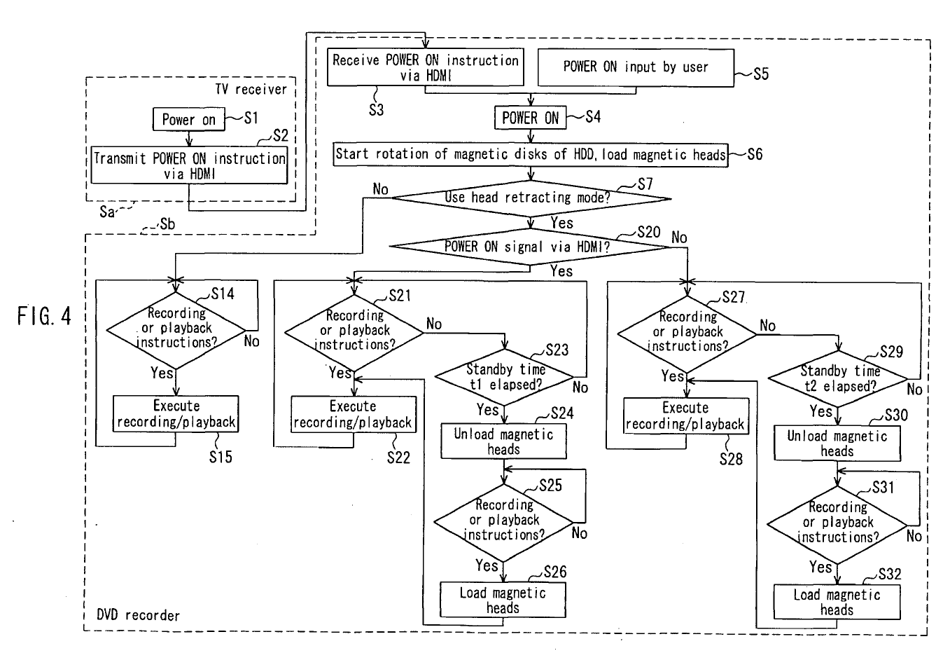

An image displaying system used in Embodiment 2 of the present invention will be described with reference to FIG. 4. The basic configuration of the image displaying system is the same as the one illustrated in FIG. 1 and FIG. 2 of Embodiment 1. FIG. 4 is a flow chart illustrating the operation of magnetic head retracting in the present embodiment. In the same figure, steps identical to the steps illustrated in FIG. 3 are assigned the same reference numerals, and their explanation is not repeated.

The difference between the present embodiment and the process flow of Embodiment 1 consists in the fact that, if a selection is made to use the head retracting mode in Step S7, then in Step S20, a determination is made as to whether the power-on of the DVD recorder 20 is performed using a POWER ON signal transmitted through the HDMI interface.

If a POWER ON signal is transmitted through the HDMI interface, then the process of Steps S21-S26 is carried out. If no POWER ON signal is transmitted through the HDMI interface and the power-on of the DVD recorder 20 is carried out based on direct operational input by the user on the DVD recorder 20 (step S5), the process of Steps S27-S32 is carried out.

Both processes are basically the same as the process of Steps S8-S13 in Embodiment 1. The difference between Steps S21-S26 and Steps S27-S32 resides in the fact that the standby time t1 in Step S23 is different from the standby time t2 in Step S29.

Namely, if the power-on of the DVD recorder 20 is performed in step with the power-on of the TV receiver 1 through the HDMI interface, control is exercised with the standby time t set to t1. On the other hand, if the power-on of the DVD recorder 20 is carried out based on direct operational input, control is exercised with the standby time t set to t2. In addition, the standby times t1 and t2 are set so as to satisfy the condition t1<t2.

The different ways in which control is exercised account for the fact that in some cases the user may have no intention to use the DVD recorder 20 when the power-on of the DVD recorder 20 is performed in step with the power-on of the TV receiver 1. If there is no intention to use the DVD recorder 20, it is desirable to enter the head retracting mode at an early stage upon power-on. On the other hand, if the DVD recorder 20 is powered on based on direct operational input, there is a high probability of recording/playback using the HDD 26. Accordingly, the standby time t is extended and the loaded state of the magnetic head is maintained, thereby enabling quick response to recording/playback instructions.

The relationship between the standby times t1 and t2 preferably is set to satisfy the condition 6×t1≦t2.

This condition is based on the mean value of the time elapsed from the power-on of the DVD recorder 20 or the issuance of an operating instruction regarding recording/playback until the issuance of the next operating instruction, which was obtained by examining the actual use of image displaying systems. As a result, a proper balance is achieved between the effect of avoiding HDD malfunctions by entering the head retracting mode at an early stage when the power-on of the DVD recorder 20 is carried out through the HDMI interface and the effect of enabling a quick response to an operating instruction regarding recording/playback by maintaining the loaded state when the power-on of the DVD recorder 20 is carried out based on direct operational input.

Furthermore, the standby time t1 preferably is set to 5 minutes or more. As a result, the magnetic head is retracted off of the magnetic disk surface upon elapse of the time slot, during which the image recording/playback apparatus is highly likely to be used. Accordingly, this is sufficient to address the desire to start recording immediately and makes it possible to minimize the probability of HDD malfunction occurrence.

### Embodiment 3

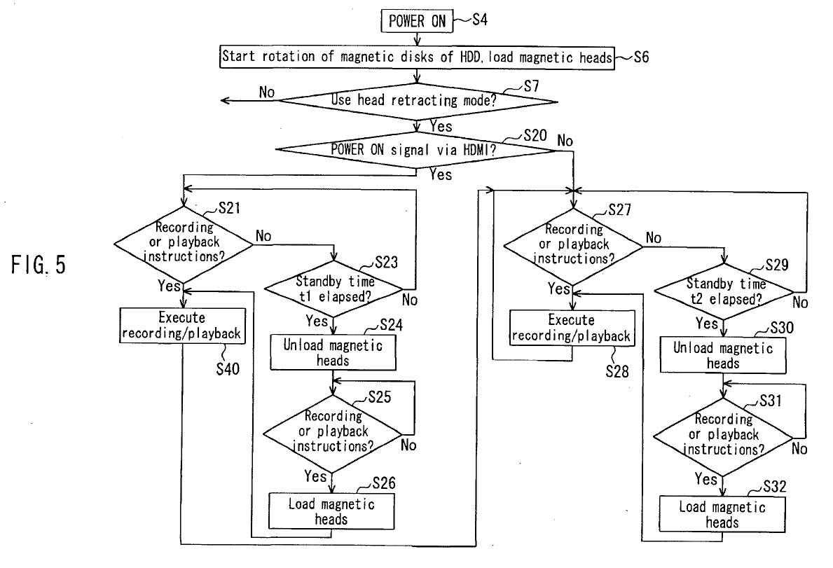

An image displaying system used in Embodiment 3 of the present invention will be described with reference to FIG. 5. The basic configuration of the image displaying system is the same as the one shown in FIG. 1 and FIG. 2 of Embodiment 1. FIG. 5 is a flow chart illustrating the operation of magnetic head retracting in the present embodiment. The present embodiment represents an improvement to the configuration of Embodiment 2. Accordingly, FIG. 5 illustrates steps in a portion of FIG. 4, i.e. the steps subsequent to Step S4. Moreover, only the use of the head retracting mode is shown after Step S7, and steps identical to the steps illustrated in FIG. 4 are assigned the same reference numerals, and their explanation is not repeated.

In the present embodiment, after Step S20, the processing that takes place after moving to Step S21, wherein the power-on of the DVD recorder 20 is carried out through the HDMI interface, is different from the process flow of Embodiment 2. After Step S20, the processing of Steps S27-S32, wherein the power-on of the DVD recorder 20 is carried out based on direct operational input is the same as the process flow of Embodiment 2.

When a recording or playback instruction is issued in Step S21, Step S40 is executed instead of Step S22 of Embodiment 2. After executing the recording/playback of Step S40, the process moves to Step S27. Namely, the process shifts to Steps S27-S32 wherein the power-on of the DVD recorder 20 is carried out based on direct operational input.

The resulting change in the process resides in the fact that while the standby time t used in Step S23 prior to the shift is t1, the standby time t used in Step S29 after the shift is t2. Namely, the point is that once a recording or playback instruction is issued, the potential for the issuance of another recording/playback instruction increases, and, accordingly, the standby time t is extended to enable quick response to recording/playback instructions.

Based on the above, in the present embodiment, when the operating instruction regarding recording/playback is issued while control is exercised with the standby time t set to t1, the setting of the standby time t is subsequently changed from t1 to t2.

### Embodiment 4

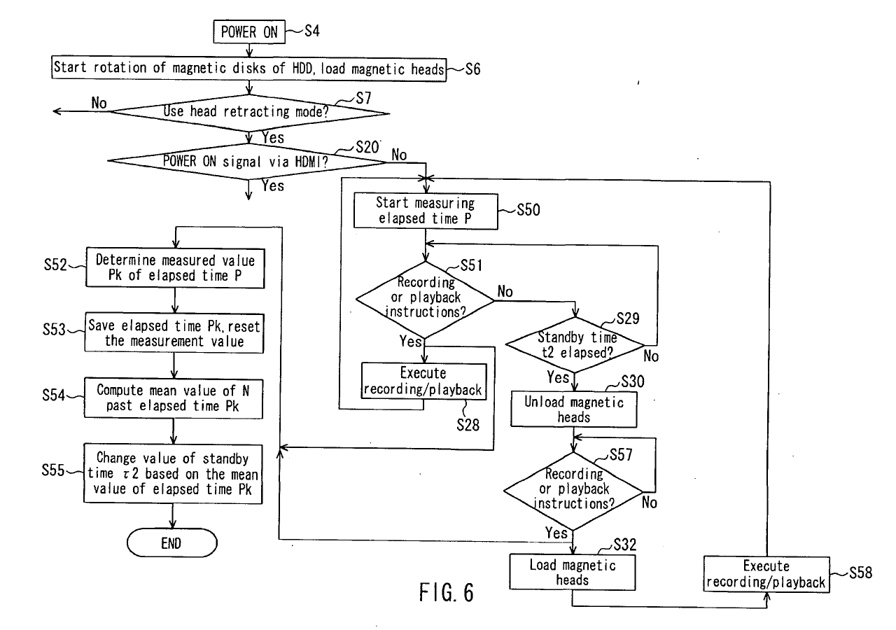

An image displaying system used in Embodiment 4 of the present invention will be described with reference to FIG. 6. The basic configuration of the image displaying system is the same as the one illustrated in FIG. 1 and FIG. 2 of Embodiment 1. FIG. 6 is a flow chart illustrating the operation of magnetic head retracting in the present embodiment.

The present embodiment is an improvement to the configuration of Embodiments 2 or 3, wherein the process executed when the power-on of the DVD recorder 20 is carried out based on direct operational input as a result of determination in Step S20 is different from that of Embodiment 2 or 3. Accordingly, FIG. 6 illustrates steps contained in a portion of FIG. 5, namely, only the steps subsequent to Step S4 executed when the determination in Step S20 is “NO”. The rest of the steps are identical to the process flow of Embodiment 2 or 3. In addition, steps identical to the steps illustrated in FIG. 5 are assigned the same reference numerals, and their explanation is not repeated.

If the determination made in Step S20 is “NO”, i.e. if the power-on of the DVD recorder 20 is carried out based on direct operational input, the measurement of the elapsed time P is initiated (Step S50). The elapsed time P is defined as the time that passes from the power-on of the DVD recorder 20 or the issuance of an operating instruction regarding recording/playback until the issuance of the next operating instruction.

The process moves from Step S50 to Step S51, where a determination is made as to the presence of operating instructions regarding recording/playback. If there is an operating instruction regarding recording/playback, the process branches into Step S28 and Step S52 and the corresponding processing is carried out.

In Step S52, the measurement of the elapsed time P is terminated at the moment of issuance of an operating instruction regarding recording/playback and a measured value Pk is determined. Next, in Step S53, the elapsed time Pk is saved and the measured value is reset. Furthermore, a mean value Pm of the elapsed times Pk according to measurement results for N saved past measurements is calculated (Step S54), the value of the standby time t2 used in Step S29 is changed based on the mean value Pm (step S55), and the process is terminated.

With regard to changing the standby time t2, when, for instance, the mean value Pm of the elapsed time Pk satisfies the condition Pm>t2, the mean standby time is long, and, accordingly it is preferable to unload the head at an earlier stage in order to ensure reliability. Namely, it is preferable to shorten t2 and use t2(1-a), wherein the value a changes depending on the length of Pm. Moreover, if the mean value Pm of the elapsed time Pk satisfies the condition Pm<t2, the average standby time is short and, accordingly, it is preferable to maintain t2 at the original value of t2 in order to emphasize better response performance.

Moreover, in Step S54, instead of calculating the mean value of the elapsed time Pk, it is possible to calculate data based on other suitable statistical processing and change the standby time t2 based on this statistical data.

Upon carrying out recording/playback in Step S28, the process goes back to Step S50, the measurement of the elapsed time P is initiated, and the above-described steps are repeated.

As long as there are no recording/playback instructions in Step S51, in Step S29, the process waits until a predetermined standby time t2 passes. Accordingly, the process goes back to Step S51 and makes a determination as to the presence of recording or playback instructions until the standby time t2 elapses.

If the standby time t2 passes without any recording/playback instructions being issued, the magnetic head is unloaded (Step S30). Next, in Step S57, a determination is made as to the presence of recording/playback instructions. If there are no recording/playback instructions in Step S57, the unloaded state is maintained and the determination as to the presence of recording/playback instructions is repeated.

If there is a recording/playback instruction in Step S57, the process branches into Step S32 and Step S52 and the corresponding processing is carried out. The operations performed in Steps S52-S55 are as described above. The operation performed in Step S58 subsequent to Step S32 is the same as the operation performed in Step S28.

In this manner, in the present embodiment, when the power-on of the DVD recorder 20 is carried out not through the HDMI interface, but based on direct operational input, the time intervals at which the recording/playback instructions are issued are measured and the standby time t2 is set based on the actual situation, in which recording/playback is performed. As a result, the standby time t2 can be adjusted to a more appropriate length.

What is claimed is:

1. An image displaying system comprising:
an image recording/playback apparatus capable of recording and playing back video data using a hard disk drive;
an image display apparatus capable of receiving and displaying TV broadcasts or effecting display based on the video data played back by the image recording/playback apparatus; and
a communication interface for effecting communication between the image display apparatus and image recording/playback apparatus with a view to integrate the function of both apparatuses,
the image recording/playback apparatus being powered on through the communication interface in step with the power-on of the image display apparatus to allow for the video data played back by the image recording/playback apparatus to be supplied to the image display apparatus,
wherein the image recording/playback apparatus comprises a control section exercising control in such a manner that, upon power-on, along with maintaining a magnetic disk in the hard disk drive in rotation, a magnetic head is brought in a loaded state in which it is held above the surface of the magnetic disk, and, upon elapse of a predetermined standby time t in the loaded state without receiving an operating instruction regarding recording or playback, the magnetic head is retracted off of the surface of the magnetic disk.

2. The image displaying system according to claim 1,
wherein the control section exercises control with the standby time t set to t1 if the power-on of the image recording/playback apparatus is performed in step with the power-on of the image display apparatus, and exercises control with the standby time t set to t2 if the power-on of the image recording/playback apparatus is performed directly, and
the standby times t1 and t2 is set so as to satisfy the condition t1<t2.

3. The image displaying system according to claim 2, wherein the issuance of the operating instruction when control is exercised with the standby time t set to t1 causes the setting of the subsequent standby time t to be changed from t1 to t2.

4. The image displaying system according to claim 2,
wherein the control section has a function for successively measuring and recording a time P that elapses between the power-on of the image recording/playback apparatus or the issuance of the operating instruction and the issuance of the next operating instruction, and
the value of the standby time t2 is changed based on statistical data on the historical values of the elapsed time P measured a predetermined number of times.

5. The image displaying system according to claim 2, wherein the relationship between the standby times t1 and t2 is set so as to satisfy the condition 6×t1≦t2.

6. The image displaying system according to claim 2, wherein the standby time t1 is set to 5 minutes or more.
